(19) United States
(12) Patent Application Publication
(10) Pub. No.: US 2025/0293834 A1
(43) Pub. Date: Sep. 18, 2025

(54) METHODS AND APPARATUSES FOR POSITIONING REFERENCE SIGNAL TRANSMISSION IN SIDELINK COMMUNICATIONS

(71) Applicant: TOYOTA JIDOSHA KABUSHIKI KAISHA, Toyota-shi, Aichi-ken (JP)

(72) Inventors: Yong LIU, Shanghai (CN); Ling YU, Kauniainen (FI); Mikko SAILY, Laukkoski (FI); Takayuki SHIMIZU, Mountain View, CA (US)

(73) Assignee: TOYOTA JIDOSHA KABUSHIKI KAISHA, Toyota-shi, Aichi-ken (JP)

(21) Appl. No.: 18/860,286

(22) PCT Filed: Apr. 26, 2023
(86) PCT No.: PCT/JP2023/016540

§ 371 Date: Oct. 25, 2024

Related U.S. Application Data
(60) Provisional application No. 63/335,598, filed on Apr. 27, 2022.

(51) Int. Cl. H04L 5/00; H04W 72/25; H04W 92/18

(52) U.S. Cl. CPC H04L 5/0051; H04W 72/25; H04W 92/18

(57) ABSTRACT

A method for a user equipment in a sidelink communication. The method includes: obtaining, by the user equipment, configuration information that defines a set of resource periods for obtaining one or more positioning reference signals from one or more anchor devices; determining, by the user equipment, a period of the one or more positioning reference signals; determining, by the user equipment, whether to transmit to the one or more anchor devices, a request to change the period of the one or more positioning reference signals based on a comparison of the determined period of the one or more positioning reference signals with at least one of: one or more predetermined periods or a period requested by one or more other user equipment; and transmitting, by the user equipment, based on the determining whether to transmit, the request to change the period of the one or more positioning reference signals.

This application claims the benefit of U.S. Provisional Application No. 63/335,598, entitled SCHEME OF SEMI-DYNAMIC PRS TRANSMISSION FROM RSU FOR SIDELINK POSITIONING and filed on Apr. 27, 2022. U.S. Provisional Application No. 63/335,598 is incorporated in its entirety by reference herein.

### TECHNICAL FIELD

This invention relates to a method for using a user equipment in a sidelink communication, an apparatus for positioning in a sidelink communication and a non-transitory computer-readable medium.

### BACKGROUND ART

Generally described, computing devices and communication networks can be utilized to exchange information. In a common application, a computing device can request/transmit data with another computing device via the communication network. More specifically, computing devices may utilize a wireless communication network to exchange information or establish communication channels.

Wireless communication networks can include a wide variety of devices that include or access components to access a wireless communication network. Such devices can utilize the wireless communication network to facilitate interactions with other devices that can access the wireless communication network or to facilitate interaction, through the wireless communication network, with devices utilizing other communication networks. In addition, or alternatively, devices can communicate directly between each other without going through the wireless communication network, or without utilizing the wireless communication network, at some times or all times.

In the context of vehicles or other mobile apparatus, communication networks can be configured to provide communication among vehicles (or integrated components) which are equipped with wireless interfaces. There are numerous approaches to implement such wireless communication network, such as in the 802.xx air interfaces promulgated by the Institute of Electrical and Electronics Engineer (“IEEE”). Another approach to such wireless communication networks correspond to cellular-based communication networks, specifically, the New Radio (NR) and its capability to support sidelink (SL) communication.

### SUMMARY OF INVENTION

The present invention in its first aspect provides a method for using a user equipment in a sidelink communication. The method comprises: obtaining, by the user equipment, configuration information that defines a set of resource periods for obtaining one or more positioning reference signals from one or more anchor devices; determining, by the user equipment, a period of the one or more positioning reference signals; determining, by the user equipment, whether to transmit to the one or more anchor devices, a request to change the period of the one or more positioning reference signals based on a comparison of the determined period of the one or more positioning reference signals with at least one of: one or more predetermined periods or a period requested by one or more other user equipment; and transmitting, by the user equipment, based on the determining whether to transmit, the request to change the period of the one or more positioning reference signals.

The present invention in its second aspect provides an apparatus for positioning in a sidelink communication. The apparatus comprises: a memory storing an instruction; and a processor configured to execute the instruction stored in the memory to: obtain configuration information that defines a set of resource periods for obtaining one or more positioning reference signals from one or more anchor devices; determine a period of the one or more positioning reference signals; determine whether to transmit to the one or more anchor devices, a request to change the period of the one or more positioning reference signals based on a comparison of the determined period of the one or more positioning reference signals with at least one of: one or more predetermined periods or a period requested by one or more other user equipment; and transmit, based on the determining whether to transmit, the request to change the period of the one or more positioning reference signals.

The present invention in its third aspect provides a non-transitory computer-readable medium storing instructions that are executable by one or more processors of an apparatus to perform a method for positioning in a sidelink communication. The method comprises: obtaining, by the apparatus, configuration information that defines a set of resource periods for obtaining the positioning reference signals from one or more anchor devices; determining, by the apparatus, a period of the one or more positioning reference signals; determining, by the apparatus, whether to transmit to the one or more anchor devices, a request to change the period of the one or more positioning reference signals based on a comparison of the determined period of the one or more positioning reference signals with one or more predetermined periods or a period requested by one or more other user equipment; and transmitting, by the apparatus, based on the determining whether to transmit, the request to change the period of the one or more positioning reference signals.

### BRIEF DESCRIPTION OF DRAWINGS

Various features will now be described with reference to the following drawings. Throughout the drawings, reference numbers may be re-used to indicate correspondence between referenced elements. The drawings are provided to illustrate examples described herein and are not intended to limit the scope of the disclosure.

FIG. 1 is a block diagram depicting an exemplary communication system, consistent with some embodiments of the present application.

FIG. 2A depicts one embodiment of an architecture of an illustrative Road Side Unit (RSU) for implementing one or more aspects of the present application.

FIG. 2B depicts one embodiment of an architecture of an illustrative User Equipment (UE) for implementing one or more aspects of the present application.

FIG. 2C depicts one embodiment of an architecture of an illustrative Next Generation Node B (gNB) for implementing one or more aspects of the present application.

FIG. 3 is a block diagram illustrative of the allocation of resources from a resource pool in accordance with sidelink-based communications.

FIG. 4 depicts implementation of different embodiments of a selection window in accordance with aspects of the present application.

FIG. 5 is a flow diagram depicting an example routine for request resource processing implemented by a UE in accordance with aspects of the present application.

FIG. 6 is a flow diagram depicting an example routine for request resource processing implemented by a RSU in accordance with aspects of the present application.

### DESCRIPTION OF EMBODIMENTS

Aspects of the present disclosure relate to systems and methods for exchange of positioning information and/or signals. More specifically, one or more aspects of the present application correspond to a mixed scheme of fixed and dynamic positioning data transmissions from one or more devices to one or more mobile devices in accordance with one or more cellular communication radio interfaces. Illustratively, the devices that transmit Positioning Reference Signal (PRS) can correspond to one or more devices, which may be generally referred to as roadside units (“RSUs”), “anchors,” or “UEs”. Reference to RSUs or anchors throughout the present application is not intended to be limiting in any manner to configuration of any particular device or difference in functionality and should be considered interchangeable unless expressly described. The mobile device can correspond to one or more user equipment (“UEs”), which may correspond devices that are capable of being in motion (directly or indirectly). The anchors and UEs are configured to exchange positioning signals in the form of positioning reference signals (“PRS”). By way of illustration, positioning signals can include signals, such as preconfigured or predetermined signals, that may not include additional or supplemental information. The PRS transmitted by anchors to UEs may be utilized by UEs for purposes of positioning solutions based on one or more techniques, including but not limited to, Time Difference of Arrival (TDOA), Angle of Departure (AoD), Angle of Arrival (AoA), Round Trip Time (RTT), and the like.

The anchors and UEs are in wireless communication via wireless interfaces hosted by infrastructure equipment, generally referred to as a gNB, in in-coverage and partial coverage scenarios or without gNB in out-of-coverage scenarios. Other common terms for such type of infrastructure equipment that interfaces with devices, such as anchors and UEs, are eNB, base stations, and the like. Illustratively, the gNB or pre-configuration configures fixed and dedicated communication channel resources for PRS transmissions from anchors with a limited set of resource periods. The limited set of resource periods allows UEs to transmit sequence-based requests to the RSU to transmit PRS using one set of resource periods. Thereafter, individual anchors transmit the requested PRS which are of the smallest period requested from all relevant UEs. The PRS transmissions illustratively employ a pre-determined sequence corresponding to the period to facilitate the period information acquirement at the UEs quickly without extra signaling. Any non-used PRS resources from anchor(s) can then be used by UEs for transmission of its own PRS. Illustratively, one or more aspects of the present application facilitate the transmission and receipt of information for facilitating positioning for UEs that may be in motion at different speeds with minimal signaling overhead.

Generally described, one approach to the exchange of positioning signals includes deploying a set of one or more anchors along roads or other areas of transmit, which can communicate with UEs (e.g., mobile UEs). Anchors are fixed and their locations can be easily acquired. For positioning by employing either timing-based (e.g., TDOA or RTT) or angle-based methods, transmissions of PRSs from anchors or/and from UEs are required for positioning relevant measurements.

To achieve positioning over the SL radio interface, UEs need to transmit/receive certain reference signals for positioning different from SL communication data, referred to generally as “SL positioning reference signals” (SL PRS). UEs conduct certain measurements (e.g., time of arrival, angle of arrival, etc.) on these reference signals, which are then used to calculate their position estimates. Aspects of the present application are described with regard to anchors being specific computing devices configured, at least in part, to transmit positioning signals Additionally, other UEs or devices or network entities supporting SL functionality may also function as “anchors” for purposes of positioning. SL PRS can be configured in terms of various parameters including time-frequency resources, such as bandwidth and periodicity; directivity-related parameters such as beam direction, beam width, number of beams, etc.; and transmit power.

Via SL communication, UEs (such as UEs in motion in vehicles) can regularly exchange information on their status (speed, direction, heading, etc.) to inform each other about their presence and mobility, as well as certain road conditions. Such information can be transmitted via standardized or structured messages, such as Cooperative Awareness Messages (CAMs) and Decentralized Environmental Notification Messages (DENMs) as defined by ETSI and Basic Safety Messages (BSMs) defined by SAE. While CAMs are required to be periodically broadcast, e.g., every 100 ms, by all vehicles, DENMs are rather event-triggered messages notifying of a certain event, such as broadcast upon a collision on the road. Upon receiving such messages, vehicles can adjust their maneuvers and efficiently cooperate for a safer and more efficient road traffic. In LTE V2X Sidelink PC5 and NR V2X Sidelink PC5, CAMs and DENMs and other V2X application messages can be transmitted via SL (besides UL and DL) to support a variety of use cases ranging for example from basic safety to vehicular platooning, from extended sensors to cooperative automated driving.

Compared to existing UL/DL positioning methods, SL positioning has the advantage of operating outside (or in partial) network coverage, in addition to in-coverage conditions, where network-based positioning is not applicable or not able to satisfy positioning Quality of Service QOS requirements (e.g., due to fewer anchor gNB nodes available), or when UEs are beyond the reach of GNSS and/or network coverage (e.g., in tunnels).

Design of PRS transmission is essential for the performance of positioning in term of positioning accuracy, resource efficiency, power consumption, and positioning latency etc. The state-of-the-art design makes use of fixed configuration and resource allocation for PRS transmissions to both anchors and UEs. The fixed PRS configuration and resource allocation helps UEs to detect and measure the PRS from anchors in a fast manner. One approach to implementation of a wireless network of devices (e.g., anchors and UEs) can be simplified so as to not differentiate PRS transmissions from anchors and UEs. In such an approach, a joint resource allocation is performed for PRS transmissions to both anchors and UEs alike.

On the other hand, the need of the PRS transmission frequency to achieve certain positioning accuracy requirement may be highly dependent on the speed of the mobile UE (e.g., pedestrians, cyclists, motorists, etc.). Fixed approaches can be deficient in the sense that they do not account for differences in the static nature of anchors or the dynamic nature of mobile UEs. To address, at least in part, the deficiencies associated with such approaches, in one aspect of the present application, PRS transmissions from anchors are configured in accordance with the fixed property of anchors to design efficient resource allocation for PRS transmissions.

Although aspects of the present application will be described with regard to illustrative network components, interactions, and routines, one skilled in the relevant art will appreciate that one or more aspects of the present application may be implemented in accordance with various environments, system architectures, computing device architectures and the like. Similarly, reference to specific devices, such as anchors, RSUs, UEs, gNBs, can be considered to be general references and not intended to provide additional meaning or configurations for individual computing devices. Additionally, reference to any specific types of data types, structures or interfaces are also intended solely for purposes of illustration and should not be construed as limiting. Accordingly, all examples are intended to be illustrative in nature and should not be construed as limiting.

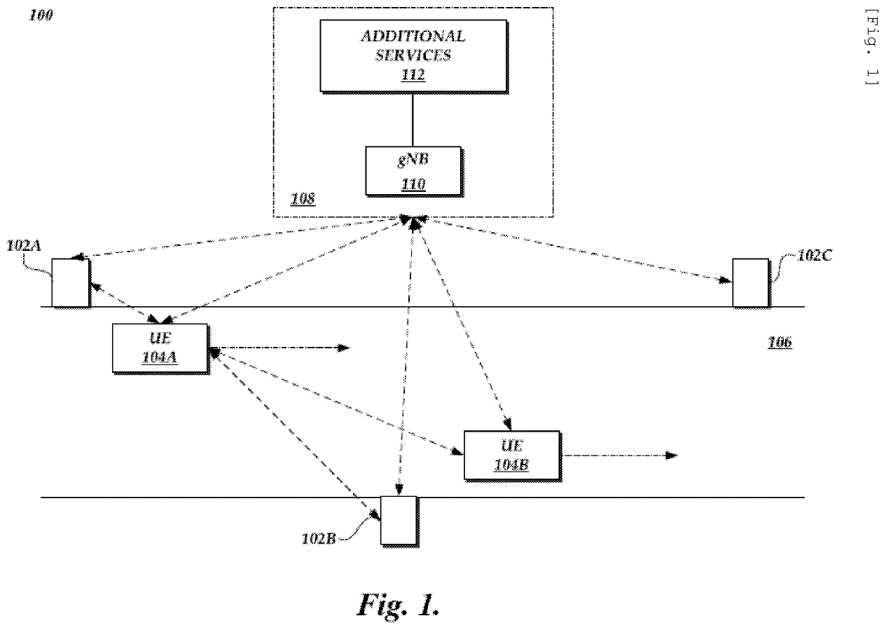

FIG. 1 depicts a block diagram of an exemplary communication system (environment) 100 for implementing one or more aspects of the present application. The environment 100 can comprise a first set of device(s) 102 (e.g., 102A, 120B) corresponding to RSU(s) that is/are located at fixed locations, such as defined locations along a transit area 106 (e.g., road or path). The environment 100 includes a second set of device(s) 104 (e.g., 104A, 104B) corresponding to UEs that are configured to be dynamically in motion, for example, along the transit area 106. In some embodiments, the RSU(s) 102 and UE(s) 104 may be in wireless communication with a gNB 110 of an infrastructure equipment 108, for example, RSU(s) 102 and the UE(s) 104 may be in a full-coverage or partial-coverage area of the wireless signals from the gNB 110. In some embodiments, the RSU(s) 102 and the UE(s) 104 may not be in wireless communication with the gNB 110, for example, the RSU(s) 102 and the UE(s) 104 may be in an out-of-coverage area of the wireless signals from the gNB 110. The RSU(s) 102 and UE(s) 104 can also be in wireless communication with one or more additional component(s) 112 of the infrastructure equipment 108 that can offload processing of information or functionality associated with the wireless network, such as the gNB 110 and a location service (LCS) server (not shown). The gNB and LCS server can be connected to the one or more additional components 112.

The communication between the gNB 110 and the anchor(s) 102 and UE(s) 104 may correspond to a Radio Access Network (RAN), such as a Next Generation RAN (NG-RAN) or 6G RAN. Other examples of RAN and core network may be implemented without departing from the scope of this disclosure. Other examples of RAN include Evolved Universal Terrestrial Radio Access Network (EUTRAN), Universal Terrestrial Radio Access Network (UTRAN), and additional variations or alternatives.

The RAN illustratively implements a Radio Access Technology (RAT), such as a New Radio (NR), Long Term Evolution (LTE) also known as Evolved Universal Terrestrial Radio Access (EUTRA), Universal Mobile Telecommunication System (UMTS), etc. The RAT of the example system of environment 100 may illustratively be NR. Different names for the RAN nodes may be used, for example depending on the RAT used for the RAN. For the illustrative example of the system of mobile communications 100 in FIG. 1, the nodes of an NG-RAN 105 may be either a next generation Node B (gNB) 110 or a next generation evolved Node B (ng-eNB). In other applications, a RAN node may be referred to as Node B (NB) in a RAN that uses the UMTS RAT. A RAN node may be referred to as an evolved Node B (eNB) in a RAN that uses LTE/EUTRA RAT. However, as indicated above, the terms base station, RAN node, gNB and ng-eNB may be used interchangeably. Additionally, reference to the infrastructure equipment 108 may be used to reference the RAN node and additional core network equipment corresponding to a wireless network.

Illustratively, the various aspects associated with infrastructure equipment 108 (gNB 110) can be implemented as one or more components that are associated with one or more functions or services. The components may correspond to software modules implemented by one or more computing device(s), which may be a separate stand-alone computing device. Accordingly, the components of gNB 110 should be considered as a logical representation of the service, not requiring any specific implementation on one or more computing devices. Additionally, the infrastructure equipment (including any additional equipment not illustrated) may be maintained by an operator such as a Mobile Network Operator (MNO), a private network operator, a Multiple System Operator (MSO), an Internet of Things (IOT) network operator, etc., and may for example offer services such as voice, data (e.g., wireless Internet access), messaging, vehicular communications services such as Vehicle to Everything (V2X) communications services, safety services, mission critical service, services in residential, commercial or industrial settings such as IoT, industrial IOT (IIOT), etc.

With continued reference to FIG. 1, illustratively the anchors 102 and UEs 104 can exchange signals, such as positioning signals, in accordance with a sidelink communication channel. Illustratively, the sidelink communication channel can correspond to NR SL, which is a physical layer composed of several physical channels and signals. The SL physical channels are a set of resource elements carrying information of higher layers of the protocol stack. The SL physical channels can include the Physical Sidelink Broadcast Channel (PSBCH) that carries the SL-BCH transport channel where the Master Information Block (MIB) for SL is sent periodically and comprises system information for UE to-UE or UE to RSU communication. The PSBCH is transmitted along with the Sidelink Primary Synchronization Signal/Sidelink Secondary Synchronization Signal (S-PSS/SSS) in the S-SSB (synchronization signal block signals). The SL physical channels can further include a Physical Sidelink Feedback Channel (PSFCH) that is used to transmit the HARQ feedback from a receiver UE/RSU to the transmitter UE on the SL for a unicast or groupcast communication. The SL physical channels can also include a Physical Sidelink Shared Channel (PSSCH) and Physical Sidelink Control Channel (PSCCH). Individual PSSCH contains transport blocks that is associated with a PSCCH. The PSCCH is transmitted on the same slot as PSSCH and contains control information about the shared channel. The Sidelink Control Information (SCI) is split into two stages. The 1st stage is sent on PSCCH, which is associated with a PSSCH, and the 2nd stage is sent over the corresponding PSSCH. Demodulation Reference Signal (DMRS) is used for PSCCH, PSSCH, and PSBCH as reference signals for demodulation of messages in a receiver.

The UE(s) 104 may include wireless transmission and reception components for communications with one or more nodes in the RAN, one or more relay nodes, or one or more anchors, or one or more other UEs, etc. Examples of UEs include, but are not limited to, smartphones, tablets, laptops, computers, wireless transmission and/or reception units in a vehicle, V2X (Vehicle to everything) or Vehicle to Vehicle (V2V) devices, wireless sensors, internet of things (IoT) devices, industrial internet of things (IIOT) devices, etc. Other names may be used for UEs such as a Mobile Station (MS), Mobile Equipment (ME), terminal equipment, terminal node, client device, mobile device, etc. Still further, UEs 104 may also include components or subcomponents integrated into other devices, such as vehicles, to provide wireless communication functionality with nodes in the RAN, other UEs, RSUs, satellite communications as described herein. Such other devices may have other functionality or multiple functionalities in addition to wireless communications. Accordingly, reference to UE may include the individual components facilitating the wireless communication as well as the entire device that incorporates components for facilitating wireless communications.

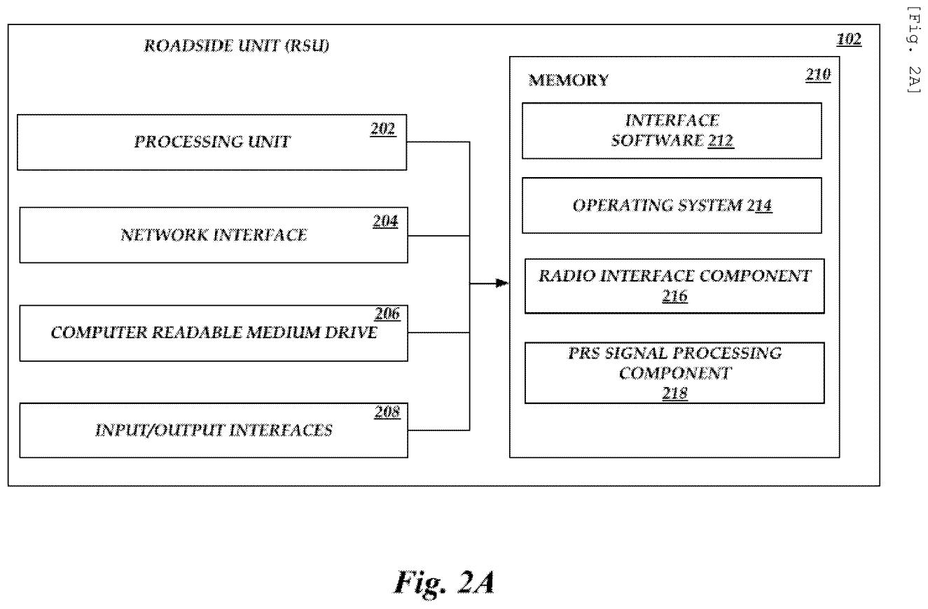

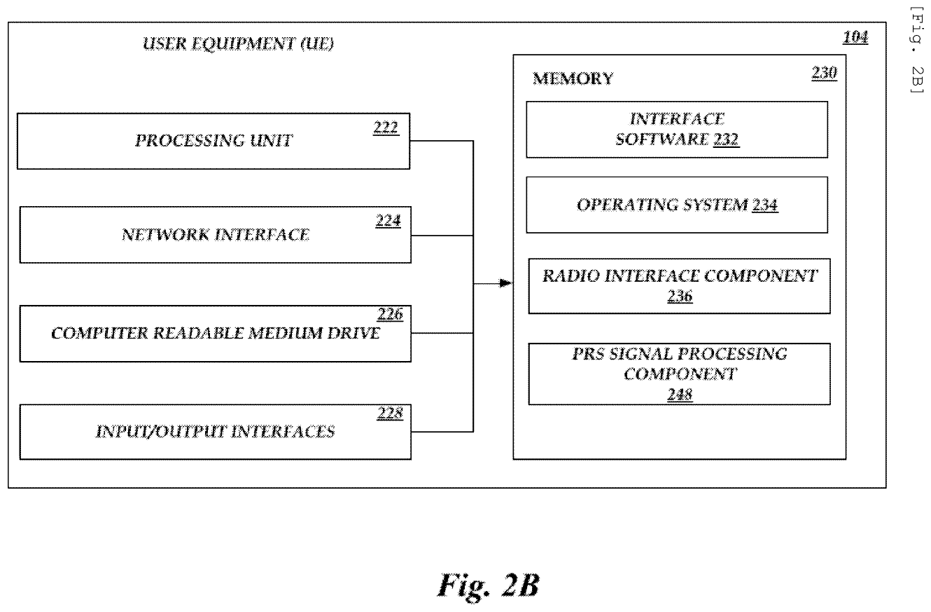

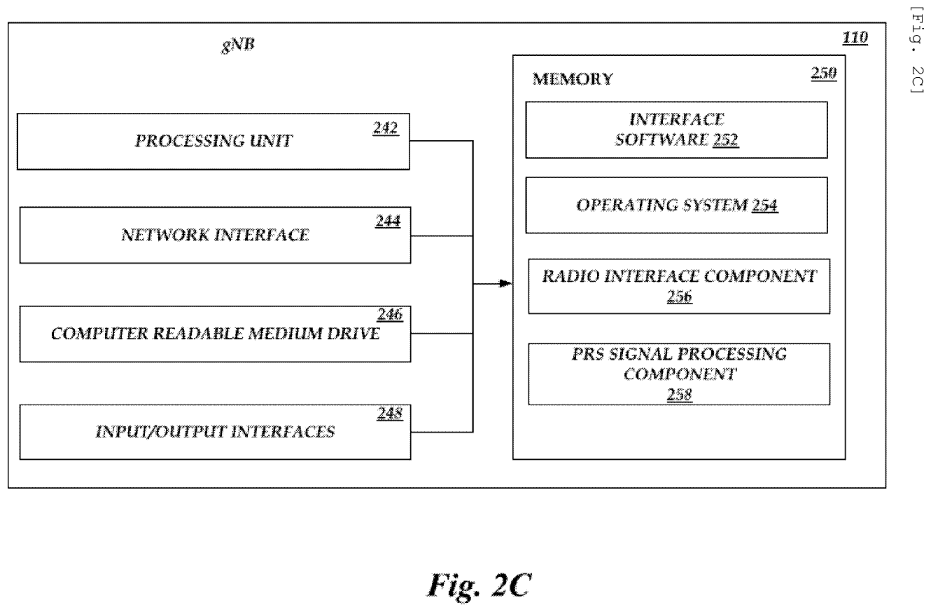

FIG. 2A depicts one embodiment of an architecture of an illustrative anchor 102 (or other anchor) for implementing one or more aspects of the present application as described. The general architecture of the anchor 102 depicted in FIG. 2A includes an arrangement of computer hardware and software components that may be used to implement aspects of the present disclosure. As previously discussed, the components of the anchor 102 may include physical hardware components, one or more virtualized components, or a combination thereof. Additionally, the components of the anchor 102 or the functionality attributed by the anchor 102 may be implemented in a virtualized environment. Such virtualized environments may be provided by the manufacturer or by a third-party entity, such as a computing service provider that can instantiate software modules that may be persistent or temporary in nature for purposes of implementing the functionality depicted in the illustrative architecture for the anchor 102.

As illustrated, the anchor 102 includes a processing unit 202, a network interface 204, a computer-readable medium drive 206, and an input/output interface 208, all of which may communicate with one another by way of a communication bus. The components of the anchor 102 may be physical hardware components or implemented in a virtualized environment.

The network interface 204 may provide connectivity to one or more networks or computing systems, such as the wireless network depicted in FIG. 1. The processing unit 202 may thus receive information and instructions from other computing systems or services via a network. The processing unit 202 may also communicate to and from memory 210 and further provide output information via the input/output interface 208, including via SL physical channels and wireless communication channels. In some embodiments, the anchor 102 may include more (or fewer) components than those shown in FIG. 2A, including one or more antennas for facilitating transmission and receipt of wireless signals.

The memory 210 may include computer program instructions that the processing unit 202 executes in order to implement one or more embodiments. The memory 210 generally includes RAM, ROM, or other persistent or non-transitory memory. The memory 210 may store an operating system 214 that provides computer program instructions for use by the processing unit 202 in the general administration and operation of the anchor 102. The memory 210 may further include computer program instructions and other information for implementing aspects of the present disclosure. For example, in one embodiment, the memory 210 includes a radio interface component 216 for processing wireless signals from the wireless network 108, UEs 104 or other anchors 102. The memory 210 includes a PRS information component 218 that is configured to provide PRS information to one or more UEs as described herein.

FIG. 2B depicts one embodiment of an architecture of an illustrative UE 104 for implementing one or more aspects of the present application as described. The general architecture of the UE 104 depicted in FIG. 2B includes an arrangement of computer hardware and software components that may be used to implement aspects of the present disclosure. As previously discussed, the components of the UE 104 may include physical hardware components, one or more virtualized components, or a combination thereof. Additionally, the components of the UE 104 or the functionality attributed by the UE 104 may be implemented in a virtualized environment. Such virtualized environments may be provided by the manufacturer or by a third-party entity, such as a computing service provider that can instantiate software modules that may be persistent or temporary in nature for purposes of implementing the functionality depicted in the illustrative architecture for the UE 104.

As illustrated, the UE 104 includes a processing unit 222, a network interface 224, a computer-readable medium drive 226, and an input/output interface 228, all of which may communicate with one another by way of a communication bus. The components of the feedback UE 104 may be physical hardware components or implemented in a virtualized environment.

The network interface 224 may provide connectivity to one or more networks or computing systems, such as the wireless network depicted in FIG. 1. The processing unit 222 may thus receive information and instructions from other computing systems or services via a network. The processing unit 222 may also communicate to and from memory 230 and further provide output information via the input/output interface 228, including via SL physical channels. In some embodiments, the UE 104 may include more (or fewer) components than those shown in FIG. 2B.

The memory 230 may include computer program instructions that the processing unit 202 executes in order to implement one or more embodiments. The memory 230 generally includes RAM, ROM, or other persistent or non-transitory memory. The memory 230 may store an operating system 234 that provides computer program instructions for use by the processing unit 222 in the general administration and operation of the UE 104. The memory 230 may further include computer program instructions and other information for implementing aspects of the present disclosure. For example, in one embodiment, the memory 230 includes a radio interface component 236 for processing wireless signals from the wireless network 108, other UEs 104 or anchors 102. The memory 230 also includes a PRS information component 238 that is configured to request PRS information from one or more anchors 102 as described herein.

FIG. 2C depicts one embodiment of an architecture of an illustrative gNB 110 for implementing one or more aspects of the present application as described. The general architecture of the gNB 110 depicted in FIG. 2C includes an arrangement of computer hardware and software components that may be used to implement aspects of the present disclosure. As previously discussed, the components of the gNB 110 may include physical hardware components, one or more virtualized components, or a combination thereof. Additionally, the components of the gNB 110 or the functionality attributed by the gNB 110 may be implemented in a virtualized environment. Such virtualized environments may be provided by the manufacturer or by a third-party entity, such as a computing service provider that can instantiate software modules that may be persistent or temporary in nature for purposes of implementing the functionality depicted in the illustrative architecture for the gNB 110.

As illustrated, the gNB 110 includes a processing unit 242, a network interface 244, a computer-readable medium drive 246, and an input/output interface 248, all of which may communicate with one another by way of a communication bus. The components of the feedback gNB 110 may be physical hardware components or implemented in a virtualized environment, including one or more antennas for facilitating transmission and receipt of wireless signals.

The network interface 244 may provide connectivity to one or more networks or computing systems, such as the wireless network depicted in FIG. 1. The processing unit 242 may thus receive information and instructions from other computing systems or services via a network. The processing unit 242 may also communicate to and from memory 250 and further provide output information via the input/output interface 248. In some embodiments, the gNB 110 may include more (or fewer) components than those shown in FIG. 2C.

The memory 250 may include computer program instructions that the processing unit 242 executes in order to implement one or more embodiments. The memory 250 generally includes RAM, ROM, or other persistent or non-transitory memory. The memory 250 may store an operating system 254 that provides computer program instructions for use by the processing unit 242 in the general administration and operation of the gNB 110. The memory 250 may include a radio interface component 256. The memory 250 may further include computer program instructions and other information for implementing aspects of the present disclosure. For example, in one embodiment, the memory 250 includes a PRS signal processing component 258 that is configured to provide PRS configuration information to one or more UEs 104 and one or more anchors 102 as described herein. A radio interface component 256 is also provided.

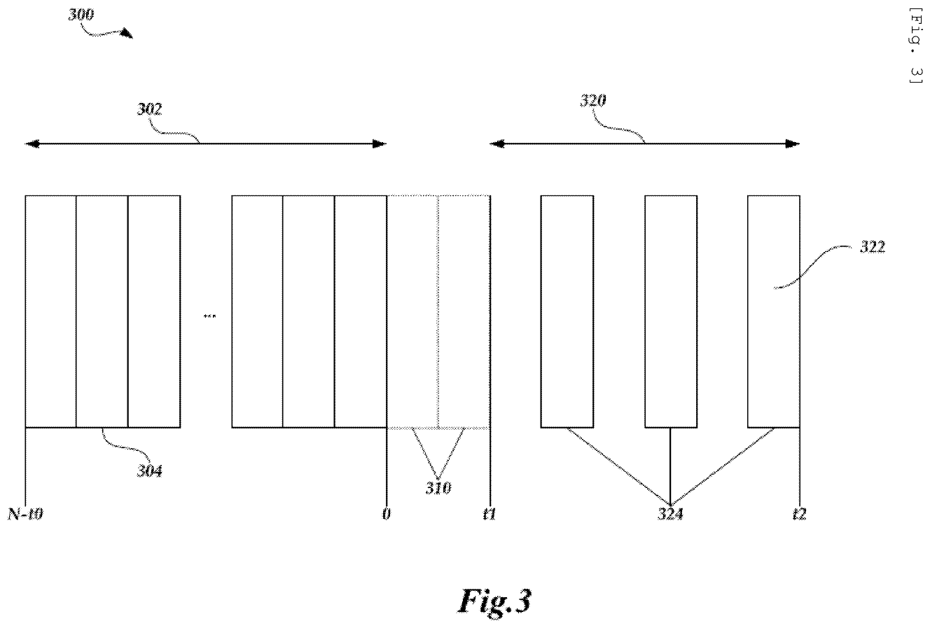

FIG. 3 is a block diagram illustrative of the allocation of resources from a resource pool in accordance with sidelink-based communications, such as NR SL-based communications. As previously described, aspects of the present application correspond to the request and exchange of PRS information utilizing a pool of allocation of radio resources. Illustratively, a resource pool limits the radio resources for PSCCH and PSSCH since they cannot be transmitted in all Resource Blocks (RBs) and slots of NR or even the frequency span of the NR SL. As applied to the present application, the concept of resource pool is also applied in autonomous resource allocation of UEs (see for example mode 2 resource allocation) where resources are selected based on a sensing procedure on a specific resource pool.

Illustratively, the UE(s) 104 and anchor(s) 102 receive the configuration of resource pool(s) through the broadcasting of a serving RAN node (e.g., gNB 110) or some dedicated signaling or use the pre-configuration of resource pools. Two modes of resource allocation may be implemented according to two modes of resource, for example Mode 1 and Mode 2. In Mode 1, resources are allocated by gNB or eNB for in-coverage UEs 104/anchors 102. There are two types of configured grants for mode 1. A first type that corresponds to a sidelink configured grant is configured/released for the UEs via RRC signaling and can be used immediately. A second type corresponds to a configured grant to activate or deactivate the configured resources through a Downlink Control Information (DCI) signaling.

In Mode 2, an autonomous resource selection by a UE 104 is based on a sensing procedure. The sensing takes place in a pre-configured resource pool. UEs can select resources for transmission and re-transmission if the resources are not in use by other UEs with higher priority traffic. A UE 104 may occupy resources for an appropriate amount of time until a re-selection event is triggered. In this mode of resource allocation, the UE 104 performs continuous sensing and when a resource selection event is triggered (e.g., arrival of a transport block) in the UE, it considers its recent sensing results within a time window. Illustratively, a UE 104, which performs sensing, measures the SL-RSRP of either PSCCH or PSSCH. This measurement is beneficial for a UE to select appropriate resources and avoid interference to any existing communication.

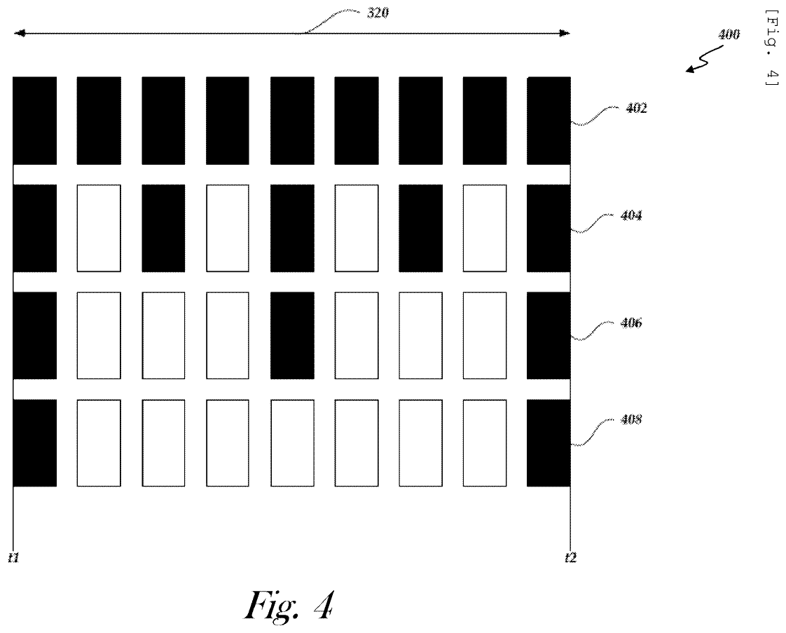

Turning now to FIG. 3, portion 302 represents an illustrative sensing window for one or more resources 304. Portion 320 represents a selection window of one or more resources 324. As will be explained in greater detail below, each individual block in the selection window 324 represents a minimum period of time for PRS transmission that are specified by gNB 110. In some embodiments, the minimum period of time for PRS transmission may be preconfigured (or can be derived) without need for additional definition. Detailed implementation of different embodiments of a selection window for purposes of PRS transmission(s) will be described with regard to FIG. 4. With continued reference to FIG. 3, two processing times 310 before and after the trigger time T1 which refers to the required time in the physical and MAC layers for processing and inter-layer information exchange.

FIG. 4 depicts implementation of different embodiments of a selection window 400 in accordance with aspects of the present application. The selection window 400 illustratively represents a subset of the block diagram for allocating resources represented in FIG. 3. Illustratively, a gNB 110 or pre-configuration configures periodic resources (with period pₘᵢₙ) dedicated for PRS transmissions from anchors 102 and configures an ordered set of N possible period values {p₁, p₂, . . . , p_{N}} which are periods of actual PRS transmissions. Each individual block depicted in FIG. 4 corresponds to the minimal resource period, pₘᵢₙ.

For example, in the selection window of FIG. 4, p₁=pₘᵢₙ, p_{N}=pₘₐₓ and pᵢ=k pₘᵢₙ where k is an integer or non-integer. Actual PRS transmissions of different periods have the same offset, which facilitates detection/estimation based on PRS at UEs 104. As an example, FIG. 4 illustrates a set of 4 PRS periods is configured as {5, 10, 20, 40} ms, at 402 (5 ms), 404 (10 ms), 406 (20 ms), and 408 (40 ms). As will be described in greater detail below, when UEs 104, such as vehicles, bicycles, pedestrians, etc. move slower (attributed UE speed is low), the period of actually used resources for PRS transmissions from anchors 102 can be made larger which reduces resource consumption and, in the meantime, can still provide requested PRS period. As will be explained in greater detail below, the UE(s) 104 and anchor(s) 102 will attempt to allocate the smallest PRS period requested from all relevant UEs to effectively transmit/receive PRS. The resulting use of the smallest period will then allow the gNB 110 (or other component) to allocate unused PRS transmission periods for UE to UE or UE to anchor PRS transmission(s).

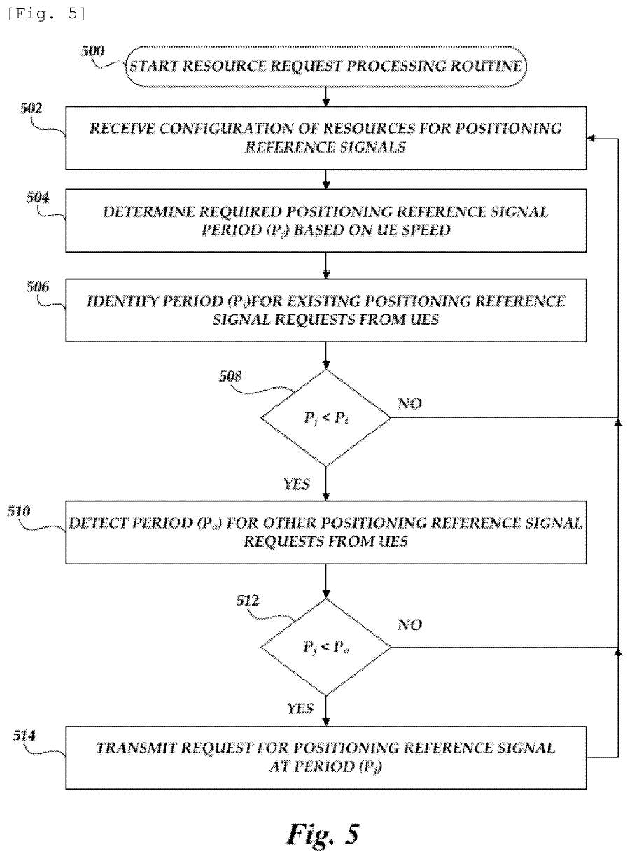

Turning to FIG. 5, a routine for request resource processing will be described. The routine may be implemented by a UE, such as the UE 104 of FIG. 1. At a block 500, a resource request processing routine is started. At a block 502, the UE obtains configuration information of resources for PRS transmission. Illustratively, the UE 104 obtains the configuration information via receiving the configuration information from a gNB, such as the gNB 110 of FIG. 1. Alternatively, the receipt of transmission information may be omitted in embodiments in which pre-configuration of the configuration information is utilized to obtain the configuration information. In one example, the configuration may have been provided to the UE 104 by the gNB at earlier times (for example, when the UE was in coverage, or in partial coverage). In another example, the pre-configuration may be defined in a relevant standard, such as the 3GPP Standards or upper layer standards, or may have been provided to the UE 104 by the PLMN, or the anchor.

In one embodiment, the gNB 110 or pre-configuration configures dedicated sidelink resources for PRS transmissions from anchors 102. This can include the gNB 110 or pre-configuration configuring the attributes (e.g., minimal size) of the periodic resources dedicated for PRS transmissions from anchors 102, which is generally referred to pₘᵢₙ. Configuring the attributes of the periodic resources dedicated for PRS transmissions based on pre-configuration may include selection of pre-configuration information. In some embodiments, configuration information may include the information received from the gNB 110 and/or the information obtained from a pre-configuration. In one embodiment corresponding to a transit area, the period pₘᵢₙ of configured PRS resources can be set based on vehicle speed limit of the road at which anchors 102 are located. Since PRS transmissions from anchors 102 can be used by all involving UEs 104 for positioning relevant measurement, the above setting can be well suited for positioning for UEs at different speeds, especially within the time frame dictated by UE travel.

The gNB 110 or pre-configuration can also determine/configure an ordered set of N possible period values {p₁, p₂, . . . , p_{N}} which are periods of configured resources with actual PRS transmissions from anchors 102. As described above and illustrated in FIG. 4, in an illustrative embodiment the set of N possible period values can be defined as p₁=pₘᵢₙ and pᵢ=k pₘᵢₙ where k is an integer or non-integer. As described previously, when vehicles move slower (vehicle speed is low), the period of actually used resources for PRS transmissions from anchors 102 can be made larger which reduces resource consumption and, in the meantime, can still provide prompt positioning. Accordingly, the largest set of N possible period values can illustratively represent the minimal non-zero velocity of the UE 104 that is supported.

At a block 504, the UE determines the required PRS period required based on vehicle speed. Illustratively, the UE 104 may be configured with pre-determined looking up information or processing rules that determine a period value based on speed. In other embodiments, the UE may determine ranges of period values or common period values that may not directly map to the actual speed. Illustratively, the UE 104 may include or have access to additional components, such as location and navigation services, that allow for the determination of speed/velocity attributes. The UE 104 illustratively will select a required period (pⱼ) based on UE speed.

At a block 506, the UE 104 checks or determines existing period (pᵢ) for the PRS transmission requested by other UEs. Illustratively, the existing period pi corresponds to the smallest period of resources that are transmitted by the anchor.

At a decision block 508, a test is conducted to determine whether the existing period (pᵢ) is greater than the determined period (pⱼ) determined by the UE 104 based on vehicle speed. If pⱼ<pᵢ, the existing period (pᵢ) is not sufficient to accommodate the UE speed. Alternatively, if pⱼ>=pᵢ, the existing period (pᵢ) is sufficient to accommodate the UE speed and the UE will not transmit the request for PRS transmission according to the sequence representing pⱼ. Routine 500 may return for update configuration or other further processing.

At a block 510, the UE 104 can detect requests from other UEs 104 and identify the smallest request period (pₒ). Illustratively, the UE checks requests transmitted from other UEs 104 to identify the PRS request sequences. Such requests can be in the form of sequences, SCIs, MAC CE, CAMs (basic safety messages), Radio Resource Control (RRC), or other V2X application messages, from other UEs 104. Illustratively, the UE 104 determines whether to request itself based on the requests from other UE.

At a decision block 512, a test is conducted to determine whether the smallest request period (pₒ) detected by the UE 104 is greater than the determined period (pⱼ). Specifically, if pⱼ<pₒ with pₒ as the smallest period requested from other UEs 104, the UE 104 transmits request with the sequence representing pⱼ. Alternatively, if pⱼ>=pₒ, the UE will not transmit the request for PRS transmission according to the sequence representing pⱼ. Routine 500 may return for update configuration or other further processing.

At a block 514, the UE will transmit the request for PRS transmission with PRS period pⱼ. In one embodiment, the request can be transmitted via a sequence which represents the resource period requested. Such a sequence-based request can reduce resource consumption and reduce latency of positioning procedure. In another embodiment, as described above, the UE 104 sends request in SCI or in MAC CE; or it embeds request in Cooperative Awareness Message (“CAM”) (basic safety message). Routine 500 returns to the block 502.

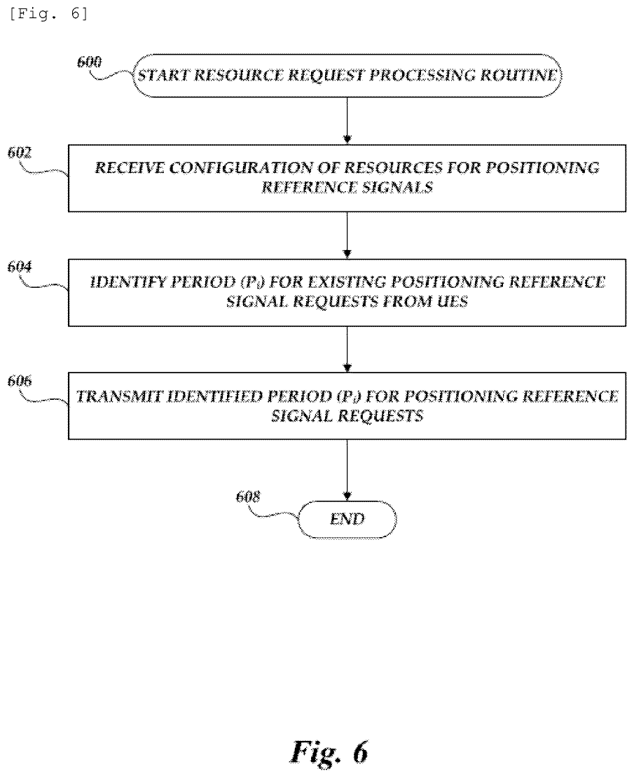

Turning now to FIG. 6, a routine for request resource processing will be described. The routine may be implemented by an anchor, such as the 102 of FIG. 1. At a block 600, a resource request processing routine is started.

At a block 602, the anchors 102 obtain configuration information of resources for PRS transmission. Illustratively, the anchors 102 obtain the configuration information via receiving the configuration information from the gNB 110 or via a pre-configuration, as described above. In one embodiment, the gNB 110 or pre-configuration configures dedicate sidelink resources for PRS transmissions between the anchors 102 and the UEs 104. This can include the gNB 110 or pre-configuration configuring the attributes (e.g., minimal size) of the periodic resources dedicated for PRS transmissions from the anchors 102, which is generally referred to pₘᵢₙ. In one embodiment corresponding to a transit area, the period pₘᵢₙ of configured PRS resources can be set based on vehicle speed limit of the road at which the anchors 102 are located. Since PRS transmissions from the anchors 102 can be used by all involving UEs 104 for positioning relevant measurement, the above setting can be well suited for positioning for UEs at different speeds, especially within the time frame dictated by UE travel.

The gNB 110 or pre-configuration can also determine/configure an ordered set of N possible period values {p₁, p₂, . . . , p_{N}} which are periods of configured resources with actual PRS transmissions from the anchors 102. As described above and illustrated in FIG. 4, in an illustrative embodiment the set of N possible period values can be defined as pₗ=pₘᵢₙ and pᵢ=k pₘᵢₙ where k is an integer or non-integer. As described previously, when vehicles move slower (vehicle speed is low), the period of actually used resources for PRS transmissions from anchor can be made larger which reduces resource consumption and, in the meantime, can still provide prompt positioning. Accordingly, the largest set of N possible period values can illustratively represent the minimal non-zero velocity of one or more UEs 104.

At a block 604, the anchor 102 collects and processes all requests received from the one or more UEs 104.

At block 606, the anchor 102 transmits the smallest period requested from the UEs, which is represented by pᵢ, and/or PRS according to the smallest period pᵢ. As described above, the period pᵢ will be used by the UEs 104 to determine whether its calculated period pⱼ is greater than or less than the smallest period requested. Illustratively, transmitting PRS with shortest period requested includes informing UEs the period of actual PRS transmissions, which can be performed implicitly or explicitly. The PRS sequence (from an anchor 102) conveys information of period, which can include different sequences for different periods, or cyclic shifts of same sequence. As explained above, the UE 104 can request lower period of PRS transmissions if needed. Routine 600 terminates at a block 608.

Clause 1 A method for using a user equipment in a sidelink communication, the method comprising:
obtaining, by the user equipment, configuration information that defines a set of resource periods for obtaining one or more positioning reference signals from one or more anchor devices;
determining, by the user equipment, a period of the one or more positioning reference signals;
determining, by the user equipment, whether to transmit to the one or more anchor devices, a request to change the period of the one or more positioning reference signals based on a comparison of the determined period of the one or more positioning reference signals with at least one of: one or more predetermined periods or a period requested by one or more other user equipment; and
transmitting, by the user equipment, based on the determining whether to transmit, the request to change the period of the one or more positioning reference signals.

Clause 2 The method as recited in Clause 1, further comprising: determining, by the user equipment, whether the determined period of the one or more positioning reference signals is less than the one or more predetermined periods.

Clause 3 The method as recited in Clause 2, wherein the period requested by the one or more other user equipment is a smallest period among one or more periods requested by the one or more other user equipment, and the method further comprises: if the determined period of the one or more positioning reference signals is less than the one or more predetermined periods, determining, by the user equipment, the smallest period requested by the one or more other user equipment.

Clause 4 The method as recited in Clause 3, further comprising: determining, by the user equipment, whether the determined period of the one or more positioning reference signals is less than the determined smallest period requested by the one or more other user equipment.

Clause 5 The method as recited in Clause 4, further comprising: if the determined period of the one or more positioning reference signals is less than the determined smallest period requested by the one or more other user equipment, transmitting, by the user equipment, the request to change the period of the one or more positioning reference signals.

Clause 6 The method as recited in Clause 2, wherein the period requested by the one or more other user equipment is a smallest period among one or more periods requested by the one or more other user equipment, and the method further comprises: if the determined period of the one or more positioning reference signals is not less than the one or more predetermined periods, iterating at least a portion of the method including the determining a period of the one or more positioning reference signals.

Clause 7 The method as recited in Clause 4, further comprising: if the determined period of the one or more positioning reference signals is not less than the determined smallest period requested by the one or more other user equipment, iterating at least a portion of the method including the determining whether the determined period of the one or more positioning reference signals is less than the one or more predetermined periods.

Clause 8 The method as recited in Clause 1, wherein the configuration information includes an ordered set of values defining a set of periods for the one or more positioning reference signals.

Clause 9 The method as recited in Clause 1, wherein the request to change the period of the one or more positioning reference signals is transmitted through at least one of: a sequence based transmission, a Sidelink Control Information (SCI) based transmission, a medium access control (MAC) control element (CE) based transmission, a Radio Resource Control (RRC) based transmission, a Cooperative Awareness Message (CAM) based transmission, or other V2X application message based transmission.

Clause 10 The method as recited in Clause 3, wherein determining, by the user equipment, the smallest period requested by the one or more other user equipment further comprises: receiving, by the user equipment, one or more sidelink signals from the one or more other user equipment, and determining the smallest period requested by the one or more other user equipment based on the received one or more sidelink signals.

Clause 11 The method as recited in Clause 1, wherein the configuration information is obtained from a network infrastructure device or a pre-configuration.

Clause 12 The method as recited in Clause 1, wherein determining, by the user equipment, the period of the one or more positioning reference signals comprises:
determining, by the user equipment, the period of the one or more positioning reference signals based on a speed of the user equipment.

Clause 13 An apparatus for positioning in a sidelink communication, the apparatus comprising:
a memory storing an instruction; and
a processor configured to execute the instruction stored in the memory to:
obtain configuration information for that defines a set of resource periods for obtaining one or more positioning reference signals from one or more anchor devices;
determine a period of the one or more positioning reference signals;
determine whether to transmit to the one or more anchor devices, a request to change the period of the one or more positioning reference signals based on a comparison of the determined period of the one or more positioning reference signals with at least one of: one or more predetermined periods or a period requested by one or more other user equipment; and
transmit based on the determining whether to transmit, the request to change the period of the one or more positioning reference signals.

Clause 14 The apparatus as recited in Clause 13, wherein the processor is further configured to: determine whether the determined period of the one or more positioning reference signals is less than the one or more predetermined periods.

Clause 15 The apparatus as recited in Clause 14, wherein the period requested by the one or more other user equipment is a smallest period among one or more periods requested by the one or more other user equipment, and the processor is further configured to: determine, if the determined period of the one or more positioning reference signals is less than the one or more predetermined periods, the smallest period requested by the one or more other user equipment.

Clause 16 The apparatus as recited in Clause 15, wherein the processor is further configured to: determine, whether the determined period of the one or more positioning reference signals is less than the determined smallest period requested by the one or more other user equipment.

Clause 17 The apparatus as recited in Clause 16, wherein the processor is further configured to: transmit, if the determined period of the one or more positioning reference signals is less than the determined smallest period requested by the one or more other user equipment, the request to change the period of the one or more positioning reference signals.

Clause 18 The apparatus as recited in Clause 14, wherein the period requested by the one or more other user equipment is a smallest period among one or more periods requested by the one or more other user equipment, and the processor is further configured to: iterate at least the determining a period of the one or more positioning reference signals, if the determined period of the one or more positioning reference signals is not less than the one or more predetermined periods.

Clause 19 The apparatus as recited in Clause 16, wherein the processor is further configured to: iterate at least the determining whether the determined period of the one or more positioning reference signals is less than the one or more predetermined periods, if the determined period of the one or more positioning reference signals is not less than the determined smallest period requested by the one or more other user equipment.

Clause 20 The apparatus as recited in Clause 13, wherein the configuration information includes an ordered set of values defining a set of periods for the one or more positioning reference signals.

Clause 21 The apparatus as recited in Clause 13, wherein the request to change the period of the one or more positioning reference signals is transmitted through at least one of: a sequence based transmission, a Sidelink Control Information (SCI) based transmission, a medium access control (MAC) control element (CE) based transmission, a Radio Resource Control (RRC) based transmission, a Cooperative Awareness Message (CAM) based transmission, or other V2X application message based transmission.

Clause 22 The apparatus as recited in Clause 15, wherein the processor is further configured to: receive one or more sidelink signals from the one or more other user equipment, and determine the smallest period requested by the one or more other user equipment based on the received one or more sidelink signals.

Clause 23 The apparatus as recited in Clause 13, wherein the configuration information is obtained from a network infrastructure device or a pre-configuration.

Clause 24 A non-transitory computer-readable medium storing instructions that are executable by one or more processors of an apparatus to perform a method for positioning in a sidelink communication, the method comprising:
obtaining, by the apparatus, configuration information that defines a set of resource periods for obtaining the positioning reference signals from one or more anchor devices;
determining, by the apparatus, a period of the one or more positioning reference signals;
determining, by the apparatus, whether to transmit to the one or more anchor devices, a request to change the period of the one or more positioning reference signals based on a comparison of the determined period of the one or more positioning reference signals with one or more predetermined periods or a period requested by one or more other user equipment; and
transmitting, by the apparatus, based on the determining whether to transmit, the request to change the period of the one or more positioning reference signals.

Clause 25 A method for managing one or more positioning reference signals in a sidelink communication, the method comprising:
obtaining, by an anchor device, configuration information that defines a set of resource periods for transmitting the one or more positioning reference signals from one or more anchor devices;
receiving, by the anchor device, one or more periods requested by one or more user equipment;
determining, by the anchor device, a smallest period requested by the one or more user equipment; and
transmitting, by the anchor device, to the one or more user equipment, one or more positioning reference signals according to the determined smallest period.

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be fully automated via software code modules, including one or more specific computer-executable instructions executed by a computing system. The computing system may include one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

Any embodiment (two or more) described in this disclosure may be used in combination. This combination may make use of logical “or”, “and”, and/or “exclusive or” between any embodiment.

Although the example of 5G NR was used in this disclosure, other Radio Access Technologies or Networks are possible, such as LTE, or 3GPP 6G. Other systems are possible, such as IEEE 802.11 and its derivatives, Wi-Fi, WiMAX, etc.

The various illustrative logical blocks and modules described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might,” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art. Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

1-25. (canceled)

26. A method for using a user equipment in a sidelink communication, the method comprising:
obtaining, by the user equipment, configuration information that defines a set of resource periods for obtaining one or more positioning reference signals from one or more anchor devices;
determining, by the user equipment, a period of the one or more positioning reference signals;
determining, by the user equipment, whether to transmit to the one or more anchor devices, a request to change the period of the one or more positioning reference signals based on a comparison of the determined period of the one or more positioning reference signals with at least one of: one or more predetermined periods or a period requested by one or more other user equipment; and
transmitting, by the user equipment, based on the determining whether to transmit, the request to change the period of the one or more positioning reference signals.

27. The method as recited in claim 26, further comprising: determining, by the user equipment, whether the determined period of the one or more positioning reference signals is less than the one or more predetermined periods.

28. The method as recited in claim 27, wherein the period requested by the one or more other user equipment is a smallest period among one or more periods requested by the one or more other user equipment, and the method further comprises: if the determined period of the one or more positioning reference signals is less than the one or more predetermined periods, determining, by the user equipment, the smallest period requested by the one or more other user equipment.

29. The method as recited in claim 28, further comprising: determining, by the user equipment, whether the determined period of the one or more positioning reference signals is less than the determined smallest period requested by the one or more other user equipment.

30. The method as recited in claim 29, further comprising: if the determined period of the one or more positioning reference signals is less than the determined smallest period requested by the one or more other user equipment, transmitting, by the user equipment, the request to change the period of the one or more positioning reference signals.

31. The method as recited in claim 27, wherein the period requested by the one or more other user equipment is a smallest period among one or more periods requested by the one or more other user equipment, and the method further comprises: if the determined period of the one or more positioning reference signals is not less than the one or more predetermined periods, iterating at least a portion of the method including the determining a period of the one or more positioning reference signals.

32. The method as recited in claim 29, further comprising: if the determined period of the one or more positioning reference signals is not less than the determined smallest period requested by the one or more other user equipment, iterating at least a portion of the method including the determining whether the determined period of the one or more positioning reference signals is less than the one or more predetermined periods.

33. The method as recited in claim 26, wherein the configuration information includes an ordered set of values defining a set of periods for the one or more positioning reference signals.

34. The method as recited in claim 26, wherein the request to change the period of the one or more positioning reference signals is transmitted through at least one of: a sequence based transmission, a Sidelink Control Information (SCI) based transmission, a medium access control (MAC) control element (CE) based transmission, a Radio Resource Control (RRC) based transmission, a Cooperative Awareness Message (CAM) based transmission, or other V2X application message based transmission.

35. The method as recited in claim 28, wherein determining, by the user equipment, the smallest period requested by the one or more other user equipment further comprises: receiving, by the user equipment, one or more sidelink signals from the one or more other user equipment, and determining the smallest period requested by the one or more other user equipment based on the received one or more sidelink signals.

36. The method as recited in claim 26, wherein the configuration information is obtained from a network infrastructure device or a pre-configuration.

37. The method as recited in claim 26, wherein determining, by the user equipment, the period of the one or more positioning reference signals comprises: determining, by the user equipment, the period of the one or more positioning reference signals based on a speed of the user equipment.

38. An apparatus for positioning in a sidelink communication, the apparatus comprising:
a memory storing an instruction; and
a processor configured to execute the instruction stored in the memory to:
obtain configuration information that defines a set of resource periods for obtaining one or more positioning reference signals from one or more anchor devices;
determine a period of the one or more positioning reference signals;
determine whether to transmit to the one or more anchor devices, a request to change the period of the one or more positioning reference signals based on a comparison of the determined period of the one or more positioning reference signals with at least one of: one or more predetermined periods or a period requested by one or more other user equipment; and
transmit, based on the determining whether to transmit, the request to change the period of the one or more positioning reference signals.

39. The apparatus as recited in claim 38, wherein the processor is further configured to: determine whether the determined period of the one or more positioning reference signals is less than the one or more predetermined periods.

40. The apparatus as recited in claim 39, wherein the period requested by the one or more other user equipment is a smallest period among one or more periods requested by the one or more other user equipment, and the processor is further configured to: determine, if the determined period of the one or more positioning reference signals is less than the one or more predetermined periods, the smallest period requested by the one or more other user equipment.

41. The apparatus as recited in claim 40, wherein the processor is further configured to: determine, whether the determined period of the one or more positioning reference signals is less than the determined smallest period requested by the one or more other user equipment.

42. The apparatus as recited in claim 41, wherein the processor is further configured to: transmit, when the determined period of the one or more positioning reference signals is less than the determined smallest period requested by the one or more other user equipment, the request to change the period of the one or more positioning reference signals.

43. The apparatus as recited in claim 39, wherein the period requested by the one or more other user equipment is a smallest period among one or more periods requested by the one or more other user equipment, and the processor is further configured to: iterate at least the determining a period of the one or more positioning reference signals, when the determined period of the one or more positioning reference signals is not less than the one or more predetermined periods.

44. A non-transitory computer-readable medium storing instructions that are executable by one or more processors of an apparatus to perform a method for positioning in a sidelink communication, the method comprising:
obtaining, by the apparatus, configuration information that defines a set of resource periods for obtaining the positioning reference signals from one or more anchor devices;
determining, by the apparatus, a period of the one or more positioning reference signals;
determining, by the apparatus, whether to transmit to the one or more anchor devices, a request to change the period of the one or more positioning reference signals based on a comparison of the determined period of the one or more positioning reference signals with one or more predetermined periods or a period requested by one or more other user equipment; and
transmitting, by the apparatus, based on the determining whether to transmit, the request to change the period of the one or more positioning reference signals.

45. A method for managing one or more positioning reference signals in a sidelink communication, the method comprising:
obtaining, by an anchor device, configuration information that defines a set of resource periods for transmitting the one or more positioning reference signals from one or more anchor devices;
receiving, by the anchor device, one or more periods requested by one or more user equipment;
determining, by the anchor device, a smallest period requested by the one or more user equipment; and
transmitting, by the anchor device, to the one or more user equipment, one or more positioning reference signals according to the determined smallest period.
